(19) United States
(12) Patent Application Publication
(10) Pub. No.: US 2015/0180915 A1
(43) Pub. Date: Jun. 25, 2015

(54) SHARING INFORMATION ABOUT RESOURCES IN A COLLABORATIVE ENVIRONMENT

(71) Applicants: April Slayden Mitchell, San Jose, CA (US); Omer Barkol, Haifa (IL)

(72) Inventors: April Slayden Mitchell, San Jose, CA (US); Omer Barkol, Haifa (IL)

(73) Assignee: Hewlett-Packard Deveolpment Company, L.P., Houston, TX (US)

(21) Appl. No.: 14/404,915

(22) PCT Filed: Jun. 1, 2012
(86) PCT No.: PCT/US2012/040589

§ 371 Date: Mar. 5, 2015

(51) Int. Cl. H04L 29/06; G06F 3/0481

(52) U.S. Cl. CPC H04L 65/403; G06F 3/0481

(57) ABSTRACT

In a collaborative environment, a plurality of elements are defined, where each element corresponds to one of a content resource, a person, or a collection. A plurality of links is determined between the plurality of elements, where each link identifies an element that is relevant to another element. A presentation can be provided for a selected element that illustrates the element and its links with other elements.

### BACKGROUND

Services currently exist to enable collaboration and document sharing. In some services, users can create silos of information, and then expose the selected information to a select set of users. Typically, a curator of the information designates who can view the information, and access to the information is limited by permission provided from the curator.

### BRIEF DESCRIPTION OF THE DRAWINGS

FIG. 1 illustrates an example system for enabling discovery and sharing of resources in a collaborative environment.

FIG. 2 illustrates an example method for establishing contextual links amongst elements in a collaborative environment.

FIG. 3 illustrates an example method in which a user can interact with an interface in order to specify resources that can be added to a collaborative environment with contextual links that identify relationships to other elements.

FIG. 4 is an example representation of how an element can be added to a collaborative environment and then linked with other elements based on relevance and the determination of relationships.

FIG. 5 illustrates an example layout for providing views of elements and linked elements in a collaborative environment.

FIG. 6A illustrates an example of a discovery view that displays a selected element in focus.

FIG. 6B illustrates an alternative view.

FIG. 6C illustrates an example of a profile view.

FIG. 6D illustrates an example of a portal view.

FIG. 7A illustrates an example of a collection view.

FIG. 7B illustrates an example of a content resource that is selected for viewing from an interface of FIG. 7A.

FIG. 7C illustrates an example of a collection interface for enabling a user to add an element to a collection.

FIG. 7D illustrates another example of a collection interface for enabling a user to add an element to a collection.

FIG. 8 illustrates an example hardware diagram for a computer system upon which examples described herein may be implemented.

### DETAILED DESCRIPTION

A collaborative environment in which resources are defined and linked to other resources based on a variety of considerations is provided. In some examples, collaborative resources are defined as elements representing people, content resources, and collections. The elements can be analyzed and linked to one another in a manner that identifies relevant relationships amongst elements. By linking elements, users can view contextual information about elements, as well as discover other elements that may be of interest to them.

According to some examples, a plurality of elements are defined, where at least some elements correspond to one of a content resource, a person, or a collection. A plurality of links is determined between the plurality of elements, where at least some of the links identify an element that is relevant to another element. A presentation can be provided for a selected element that illustrates the element and its links with other elements.

According to some examples, the presentation can include one or more views. Each view may concurrently display (i) the selected element in focus, corresponding to one of a content resource, a person, or a collection, (ii) a first set of elements corresponding to a set of persons that are linked to the element in focus, (iii) a second set of elements corresponding to one or more collections that are linked to the element in focus, and (iv) a third set of elements corresponding to one or more content resources that are linked to the element in focus.

In some examples, a plurality of elements is defined for a collaborative environment. Each of the plurality of elements may correspond to one of a content resource, a person, or a collection. A plurality of links may be determined between the plurality of elements, and each link can identify an element that is relevant to another element. The plurality of elements may include one or more collections, and each of the one or more collections can be linked with a plurality of elements that represent (i) a set of content resources that are assigned to the collection, (ii) one or more persons who are curators for the collection, and (iii) one or more persons who are followers of the collection.

Still further, some examples include a feature to enable a user to specify an element of a collaborative environment. The element may represent any one of a person, a content resource, or a collection. In response to the user specifying the element, a plurality of related elements can be determined for the specified element. The plurality of related elements can include each of (i) an element representing a person that is relevant to the specified element, and (ii) an element representing a content resource that is relevant to the specified element. One or more views can be provided that display the specified element and the plurality of elements.

One or more examples described herein provide that methods, techniques and actions performed by a computing device are performed programmatically, or as a computer-implemented method. Programmatically means through the use of code, or computer-executable instructions. A programmatically performed step may or may not be automatic.

One or more examples described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the collaborative environment described herein can be carried and/or executed. In particular, the numerous machines shown include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, examples of the collaborative environment described herein may be implemented in the form of computer-programs, or a computer usable carrier medium capable of carrying such a program.

System Description

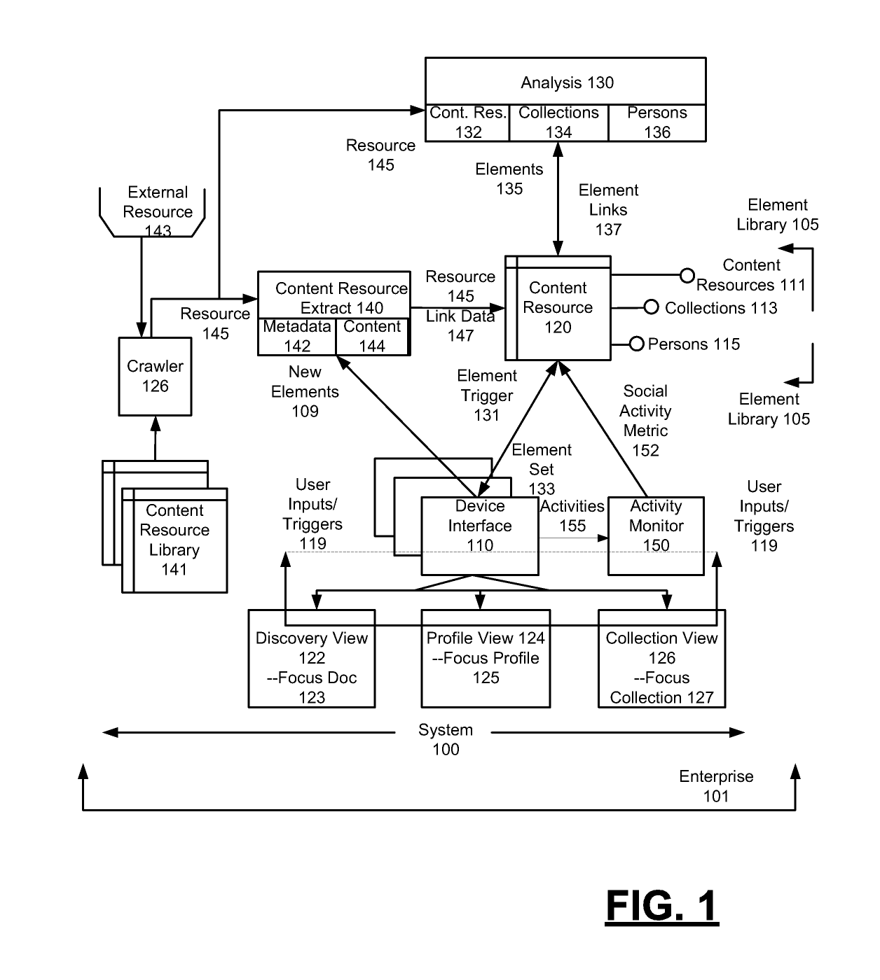

FIG. 1 illustrates an example system for enabling discovery and sharing of resources in a collaborative environment. A system 100 can be implemented as, for example, a part of an enterprise network 101. Accordingly, system 100 may be implemented by servers, workstations, terminals and other computing resources which combine to provide the functionality described. As described in greater detail, system 100 enables a collaborative environment to be implemented on an enterprise network 101. More specifically, system 100 enables a collaborative environment that enables resource sharing and discovery amongst the users of enterprise network 101. Moreover, system 100 enables social functionality that enhances the sharing and discovery amongst the users.

According to some embodiments, system 100 includes one or more device interfaces 110, one or more content resource data stores 120, and an analysis component 130. Each device interface 110 can be implemented as either a client application, network service, or shared client network resource. Additionally, each device interface 110 can be adapted to interface with a particular class of devices, such as workstations, mobile devices, and specific operating systems thereof. The content resource data store 120 can correspond to a structured memory resource that maintains information for various content resources (e.g., records, documents, media) of the enterprise network. In particular, the content resource data store 120 can include, for example, structured memory resources that store and maintain a library of elements 105 for use with system 100, where each element of the library 105 represents a defined collaborative resource of the enterprise network 101. In one embodiment, the elements represent resources in the form of content resources 111, collections 113 and persons 115. The elements representing content resources 111 can include, for example, documents, presentations, media (e.g., video or audio clips), and records (e.g., e-mails). The elements representing collections 113 can represent a defined set of content resources 111. Collections 113 typically include associated persons, including curators, followers, or participants for the collection. Thus, for example, collections can include elements representing persons, in capacity as member (e.g., contributor or curator). The elements representing persons 115 can include profile information and related data sets (e.g., biographical information, pictures, contact information, etc.) of users of the enterprise network 101.

The analysis component 130 includes logic (e.g., algorithms, processes, rules) and other programmatic functionality for analyzing elements of the element library 105, for purpose of determining relationships amongst elements of the element library 105. The determination of relationships amongst elements can be based on a variety of factors, including (i) known associations between elements based on past or current activities; (ii) determinations of relevance amongst elements, based on considerations such as subject matter relevance (e.g., as between content resources 111, collections 113, or content resources and collections), or experience (e.g., as between persons 115, or between persons 115 and content resources 111 or collections 113); and/or (iii) indirect associations between elements, based on prior or current relationships amongst elements, with one or more degrees of separation.

In some embodiments, analysis component 130 includes logic (e.g., processes, algorithms, rules) to determine relationships for each type of element (e.g., content resources, collections and persons). In one embodiment, the analysis component 130 includes content logic 132 that is adapted to determine how content resources 111 relate to other elements. The content logic 132 may utilize, for example, metadata of a content resource to determine other content items that are relevant by context based on metadata. As an addition or alternative, the content logic 132 may also utilize a content of the content resource, to understand a topic or keyword, and then match that topic or keyword to other elements by content (e.g., other elements that pertain to same topic or have same keyword) or by metadata (user profiles that are relevant to keyword). As an addition or alternative, the analysis component 130 can include collection logic 134 that is adapted to determine how collections 113 relate to other elements, including other collections, content resources, or persons.

For example, collection logic 134 may utilize content data or metadata of the content resources assigned to the collection in order to identify elements that are relevant to the particular collection. For example, the collection logic 134 may identify other documents that share a same subject as the content items of the collection, other collections which share a same curator, and/or curators who have contributed other collections or content resources.

Additionally, the analysis component 130 can also include person logic 136 that is adapted to determine how elements representing persons 115 relate to elements representing content resources, collections and other persons. For example, for a particular element, the person logic 136 can identify other users of the enterprise network 101, or other persons who have contributed to content resources 111 or collections 113 of the element library 105.

In some embodiments, the analysis component 130 analyzes elements that are maintained in the data resources of enterprise network 101 in order to determine relationships (or links) amongst the elements of the element library 105. In one implementation, the analysis component 130 analyzes elements 135 stored in the content resource data store 120. As an addition or variation, the analysis component 130 can analyze content resources 145 that are retrieved by one or more crawlers 126, which can crawl, for example, content resource library 141 and/or data nodes of the enterprise network 101, as well as other resources 143 which can optionally be external to the enterprise network 101. A result of the analysis component 130 includes determination of relationships (“element links 137”) between elements 135 under analysis and other elements of the element library 105.

The content resources of the enterprise network 101 can be processed by content resource extraction component 140. For example, content resource extraction 140 can process content resources identified by the crawler 126 (e.g., documents, files, records, web pages, etc.) to identify data for enabling the determination of relationships between that content resource and other elements that are known to system 100 (e.g., other elements stored in the resource data store 120). Such data can include metadata and content data. More specifically, the content resource extraction 140 can include a metadata component 142 to extract metadata from the identified resources 145. For example, resource 145 can correspond to a document, file, or record, and the resource 145 can be associated with metadata that includes an author, permission lists for those individuals permitted to modify the resource 145, date of creation, date of modification, tags that identify links between the resource 145 and keywords, as well as tags that identify links between the resource 145 and other resources or persons or collections. The content resource extraction 140 can also include a content component 144 that operates to extract content data 149 from the individual resources 145. For example, in the case in which the resource 145 includes a document or record, content component 144 can identify text content. In one implementation, the resource 145, as well as link data 147 in the form of extracted metadata and/or content data are stored in the content resource data store 120. The analysis component 130 can subsequently analyze the resource 145 (along with the link data 147) in order to establish relationships and links between the particular resource 145 and other elements of the element library 105 maintained through system 100. In a variation, the resource 145 can be processed by analysis component 130, so as to be analyzed and linked with other established elements on-the-fly and in response to the retrieval of the resource 145 by the crawler 126.

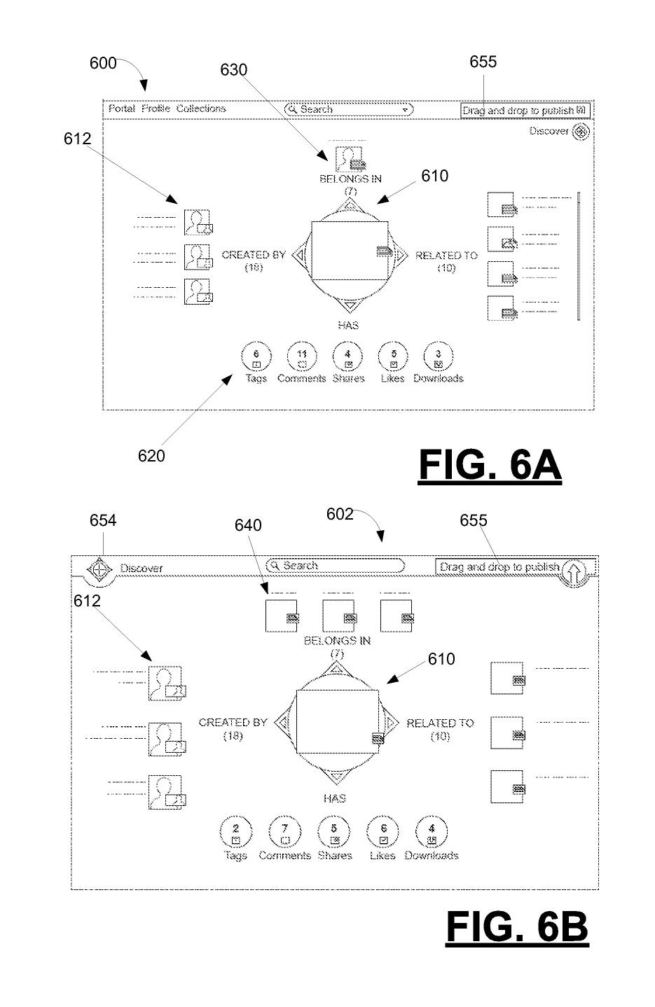

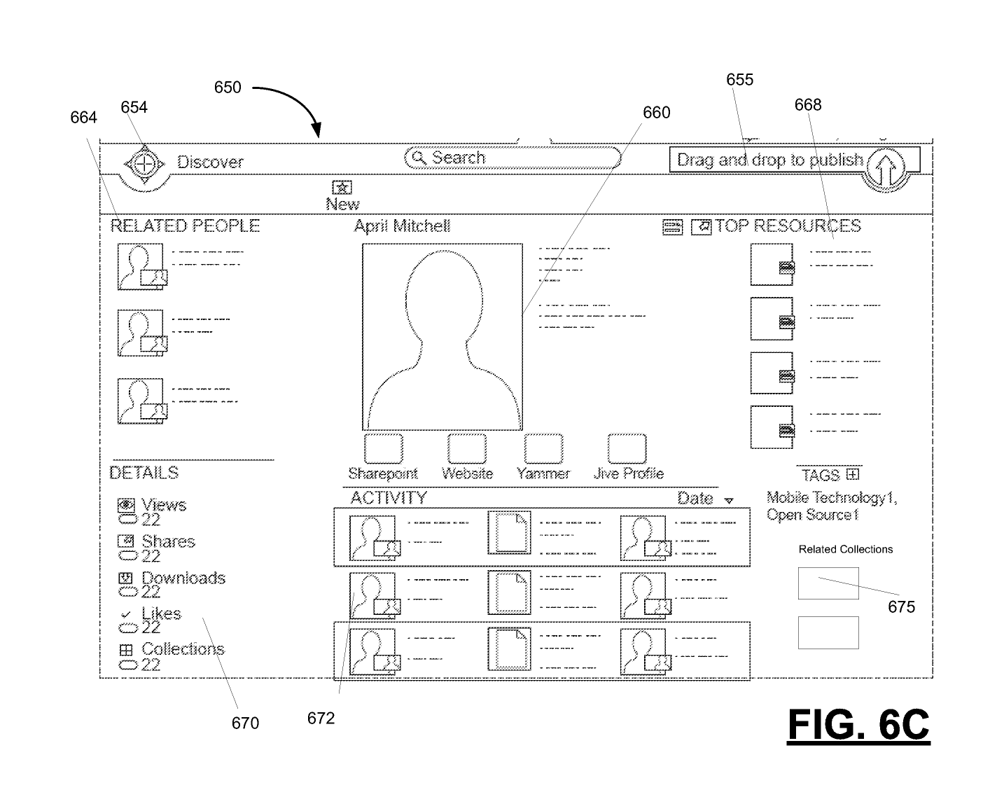

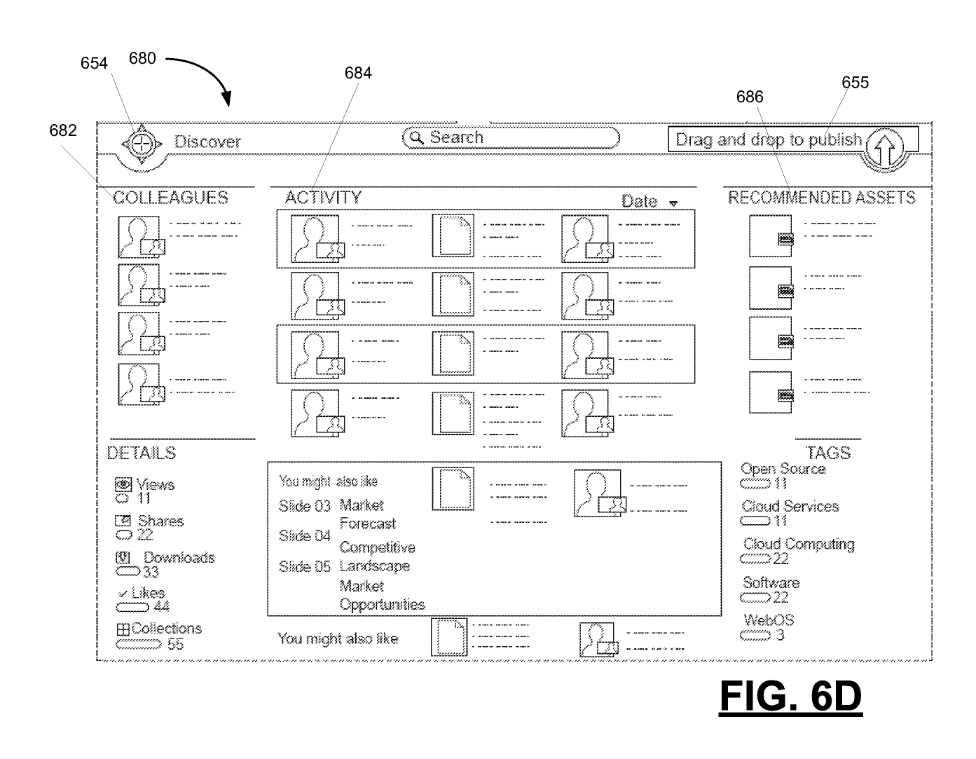

The analysis component 130 can also be adapted to analyze newly provided or created elements. In particular, the users of the system 100 can specify, for example, new elements 109, corresponding to newly identified content resources, collections or user profiles, for inclusion in the library of elements 105 maintained on system 100. In some embodiments, users can interact with features provided through one of the device interfaces in order to specify, for example, a content resource for inclusion as one of the elements in the library 105 of elements maintained by system 100. For example, as described with FIG. 6A through FIG. 6D, a user can drag a data item into an iconic feature provided through one of the views of the device interface in order to add the item to the library of elements 105. For example, the user action can add a contact record as a person element 115, or a document as a content resource 111.

Device Interface and Views

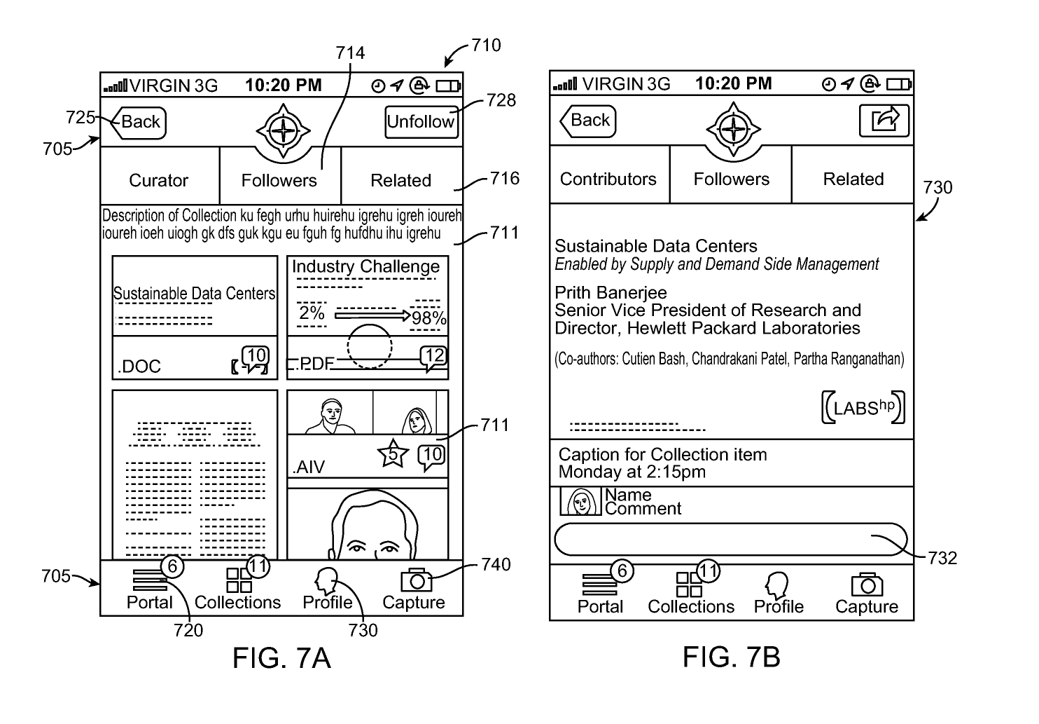

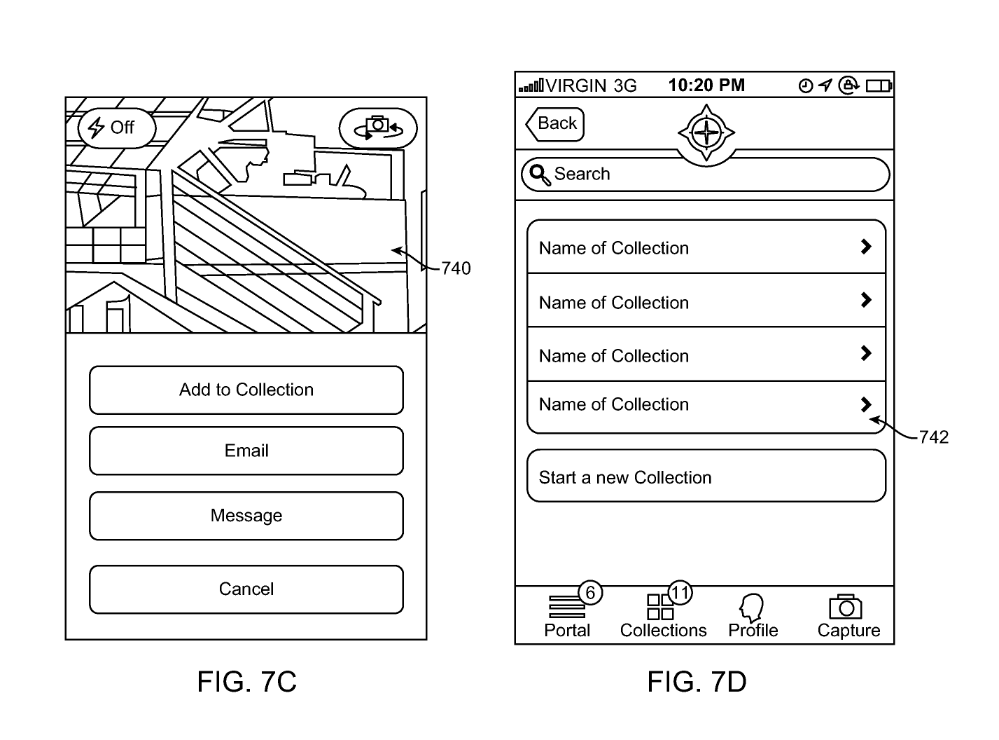

According to embodiments, the device interfaces 110 provide for presentations and functionality that enable the users of system 100 to (i) specify new elements for inclusion in the library of elements 105, (vii) view existing elements, (iii) specify links or relationships for elements, and/or (iv) modify elements. In some embodiments, presentations provided through device interface 110 include features (e.g., iconic features) to enable users to specify new elements 109 for inclusion in the library of elements 105. For example, the users can specify new content resources (e.g., documents), create a new collection, or specify a new user profile. Examples of features and functionality for enabling users to specify new elements are described with, for example, FIG. 7C and FIG. 7D. As described, some examples provide for newly identified elements 109 to be automatically analyzed for relationships to other elements. Once relationships are determined, the newly identified elements 109 can be linked with other elements of the element library 105.

The device interfaces 110 can also enable the viewing of elements, as described below. Elements can be viewed in response to, for example, user inputs or triggers 119 (e.g., user selects to view element, user performs action that causes element to be viewed). The user input/trigger 119 can result in the device interface 110 signaling an element trigger 131. The element trigger 131 can, for example, identify the particular element of the user's element (e.g., the user selects a document). As described, each element is linked with other elements based on programmatically determined relationships between elements. In response to the trigger 131, an element set 133 is returned which includes a set of elements, linked to the specified element of the request. As described below, the specified element of the request may correspond to an element of focus, and the element set 133 specifies elements that are deemed relevant to the element in focus. The relationship between the element in focus and elements in the returned set of elements 133 can be displayed in, for example, one of the views provided through the device interface 110.

Additionally, in some examples, the device interface 110 is adapted to provide a multi-view presentation for displaying resource elements with links to other relevant elements. In this way, the views provided through the device interface 110 can establish contextual and relevance links amongst the resources of the enterprise network 101. As described with some embodiments, the presentation provided through the device interface 110 can include a discovery view 122. In the discovery view, a document or other content resource can be specified as the element in focus 123. The element in focus can be visually linked to other elements, including elements representing persons that are relevant to the document in focus (e.g., contributors or authors of the document), and elements representing other documents that are relevant to the document in focus. As an addition or variation, the document in focus 123 can be associated with one or more collections. Thus, the discovery view 122 can be supplied with element representations for one or more collections that are relevant to the particular document that is in focus (e.g., collections that the document is part of). An example of a discovery view 122 can be shown with, for example, FIG. 6A.

As an addition or alternative, the presentation can include a profile view 124 which can present an element representing a person (e.g., profile information of a person) in focus. The person element can be presented with links to other elements, including (i) links to other persons that are deemed relevant to the person in focus (e.g., persons who are collaborators or contributors to the same content resources or collections, persons who share similar interests, etc.), (ii) links to content resources that are deemed relevant to the person in focus (e.g., documents that the person in focus authored, contributed to, etc.); and/or (iii) links to collections that are deemed relevant to the person in focus (e.g., collections that the person in focus was a contributor to or curator for).

As an addition or alternative, the presentation can include a collection view 126 which can present an element representing a collection element 127 in focus. The collection element 127 in focus can be presented with links to other elements, including (i) links to persons that are deemed relevant to the person in focus (e.g., persons who are collaborators or contributors to content resources of the collection, the curator for the collection, etc.), (ii) links to content resources that are deemed relevant to the collection in focus (e.g., documents that are part of the collection in focus); and/or (iii) links to other collections that are deemed relevant to the collection in focus (e.g., another collection that shares a same content resource, curator or contributor).

Activity and Social Monitoring

According to some embodiments, activities performed by users in connection with individual elements are tracked and displayed. According to an embodiment, system 100 includes an activity monitor 150 which can operate with or in connection with device interfaces 110. As an example, the activity monitor 150 can track specific activities users perform in regard to, for example, viewing or contributing to elements of the library 105 of elements. The activity monitor 150 can operate to track various kinds of activities.

According to an example, an accumulation of the activities can be displayed with corresponding elements when those elements are subsequently viewed. In some embodiments, the views 122, 124, and 126 can include social activity metrics 152 which reflect the accumulation of the activities that are tracked for the corresponding element that is in focus on that view.

For example, the activity monitor 150 tracks activities 155 that include (i) a number of downloads or views of an individual element, (ii) feedback from users (e.g., number of people who have “liked” a particular element), (iii) a number of times that individual elements are shared, (iv) comments provided in connection with an element, (v) the number of times that a person or content resource element is “collected” and (vi) the number of times that a collection element is “followed”. With regard to following an element, users can subscribe to track an element, and receive notification when a specific event occurs that affects the elements. For content resources 111, an event can correspond to the content resource being modified, shared, or added to a new collection. For collections 113, an event can correspond to a new document being added to the collection. For persons 115, an event can correspond to the person making a new contribution, being associated with a new collection, etc. Various other kinds of activities can also be tracked. Examples of social activity metrics 152 that can be displayed in connection with elements through a selected one of the views 122, 124, and 126 are provided by other examples described below.

Methodology

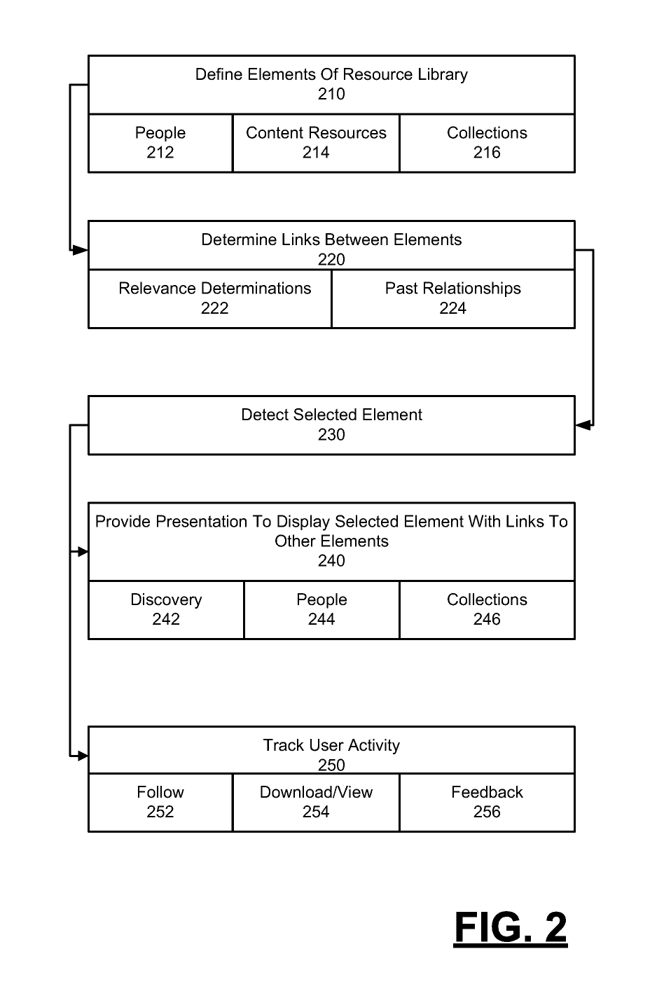

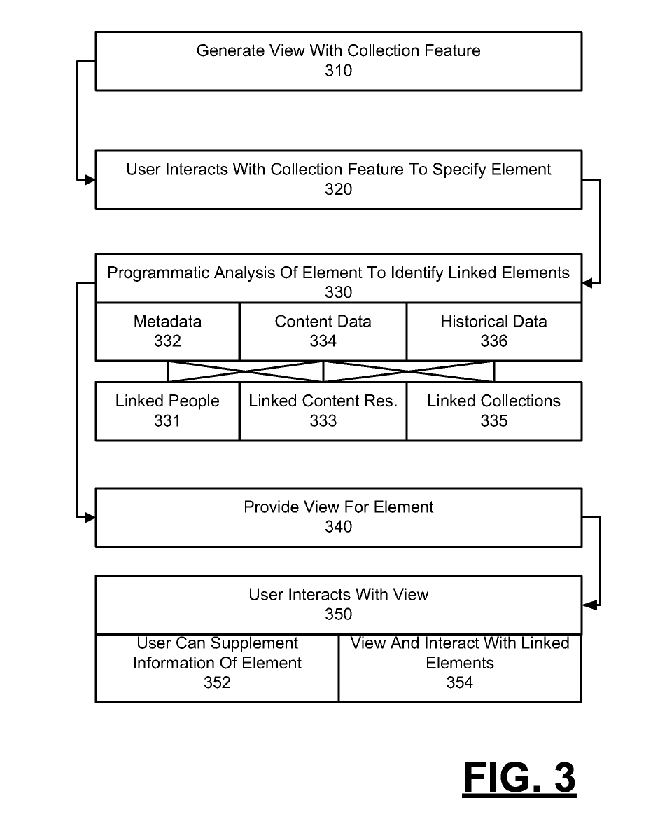

FIG. 2 illustrates an example method for establishing contextual links amongst elements in a collaborative environment. FIG. 3 illustrates an example method in which a user can interact with an interface in order to specify resources that can be added to a collaborative environment, with contextual links that identify relationships to other elements. Examples of methods such as described with FIG. 2 and FIG. 3 can be implemented using a system such as described in FIG. 1. Accordingly, reference may be made to elements of FIG. 1 for purpose of illustrating a suitable component or functionality for performing a step or sub step being described. A collaborative environment such as described by examples of FIG. 2 and FIG. 3 can be implemented on, for example, an enterprise network, and/or amongst a designated set of resources (e.g., personnel, data, etc.).

With reference to FIG. 2, the elements of an enterprise network or other collaborative environment can be defined (210). According to at least some embodiments, the elements can include person elements such as people or personnel (212), content resource elements (214), and/or collection elements (216). As examples, a list of persons who are collaborators (e.g., content contributors, editors), curators or otherwise users of the enterprise network can be identified as person elements. In some examples, person elements 212 can include profile information about a specific person, including biographical information. Content resource elements 214 can include, for example, documents, files, presentations, records, media clips, and data items. The collections elements 216 can include sets of content resources which are designated to be part of a common set. A collection can also identify persons who are contributors or curators for the collection.

In some embodiments, links that represent context and relationships amongst the elements of the collaborative environment are determined (220). The determination of links amongst elements can be based on a variety of considerations. In some examples, the determination that a link exists between two or more elements is based on a determination that the two elements are relevant to one another (222). As an addition or alternative, elements can be linked to one another based on a past relationship or link.

In more detail, for person elements 212, the links to that element can be based on information that provides context as to that person's relationship with other persons, documents or content resources 214, or collections 216. For example, a person element 212 can be linked to elements representing documents 214 or collections 216, based on a determination that the person was a contributor or curator for those documents 214 or collections 216. Person elements can be linked to other persons based on determinations that those persons are contributors or curators of a same document or collection.

As an addition or alternative, person elements 212 can identify other relationships that an identified person has with other persons. This can include, for example, an organizational hierarchy, as well as relationships that are established by activities or conduct of the particular person. For example, a person may be linked to a document 214 or a collection 216 based on a past relationship in which the person worked on a particular project. Similarly, past relationships between persons 212 and content resources 214 or collections 216 can link persons who worked on those content resources 214 or collections 216. If a person was a contributor or curator for a particular collection 216, relationships can be defined to extend to those other individuals who were contributors for the same document 214 or collection 216, or curators of the same collection 216. Numerous other examples of person relationships can be predefined and used to establish relationships, such as information shared amongst the biographical information of two persons (e.g., two people may be linked if they attended the same school, etc.).

Content resource elements 214 can be linked to persons based on relationships such as persons who are or were contributors to the content resource. Content resources 214 can be linked to other content resources based on, for example, contextual relationships such as having a common contributor or author, or belonging to a common collection.

In some embodiments, content resources 214 can also be linked to other content resources based on subject matter relevance. For example, the text of a document can be scanned and analyzed in order to determine keywords or topics that are relevant to the document. Based on this identification, the document can be linked to other documents that share the same keyword or topic.

The collection elements 216 can be linked with other elements based on contextual relationships, such as with persons who are curators or followers or are otherwise part of or associated with a collection, with content resources that are associated with the collection, or with other collection that share a same follower, curator, or content resource.

With elements of a collaborative environment defined, examples provide for views in which elements can be displayed in context of relationship with other elements. As an example, an element can be selected by a user of the collaborative environment. The element can correspond to, for example, an existing element, such as an element representing a document that has contributions from others, a collection of documents, or profiles of persons. The selection of an element can be made through a user-interface. For example, a user can select an element by dragging the corresponding data item to an iconic feature that is provided as an interface element on a computing device of the user. As another example, a user can select an element by tapping a representation of the element, right-clicking the representation, or performing a tap and hold.

In response to user selection, a presentation can be provided to the user that displays the selected element in context with at least some other elements that are linked to the selected element. Thus, for example, the selected element is displayed in context of other elements that have been determined to have a relationship to the selected element.

In some examples, the selected element and its linked elements are provided in a view that has a predefined structure or organization that can sort elements by, for example, type. Multiple views can be made available to a user. The selection of the view can be based on user-input (e.g., user selection of a particular view), or based on the type of element (e.g., person, collection, resource, etc.).

As one example, the selected view can correspond to a discovery view (242) (see also example of FIG. 6A). In the discovery view, a document or collection is centrally or prominently presented, with linked person elements provided on one side of the selected element, and related content resources on another side of the content resource. Separate positioning or links can be provided for links that are to person elements of contributors as opposed to curators.

As another example, the selected view can correspond to a people view (244), in which a person element, or set of person elements, is centrally or prominently displayed. The people view can be generated in response to, for example, the selection by the user of a person element (e.g., a profile of a user). Other elements (e.g., content resources receiving contribution from the person, etc.) that are linked to the people can be displayed as well. FIG. 6C illustrates an example of a people view.

A collection view can also be displayed (246). In the collection view 246, a collection is centrally or prominently displayed. Other elements that are associated or part of the collection (e.g., documents in the collection, curators, contributors, etc.) can be displayed concurrently with the collection. FIG. 6A and FIG. 7A illustrate examples of a collection view.

According to some embodiments, various types of user activity relating to collaborative elements are tracked and displayed in the presentations provided to the user (250). In some variations, the types of activities that are tracked are specific to the type of element. As an example, an element can be followed (252) by users. When followed, certain events can result in notifications being provided to the users that follow the element. For content resources and collections, for example, followers can receive notifications when those elements are changed or updated. For elements corresponding to people, for example, the notifications can identify when those persons perform a certain activity, such as contributing a content resource or adding a comment or adding items into a collection.

Other activity can correspond to tracking when elements are downloaded and/or viewed (254). As another addition or alternative, feedback can be received for elements (256), such as in the form of “likes” or ratings. Numerous other types of activity can be tracked for elements. In some embodiments, the activity for an element can be displayed when that element is depicted in one of the views. For example, when an element is selected and provided prominently on a view, the activity for that element can also be displayed.

In FIG. 3, a user can operate a computing device to generate a collection feature that is associated with functionality for adding elements to the collaborative environment (310). The user can interact with the collection feature to specify a data item (e.g., document, personnel file) for addition to the collaborative environment (320). For example, the user can click and drag a data item into an icon, or tap and hold the selected data item. In some examples, the user can add documents or other data items to the collaborative environment by specifying a collection that is to be associated with the newly added data item.

A programmatic analysis can be performed on the newly specified element in order to determine related elements (330). The analysis can include extracting metadata (332), content data (334), or historical data (336). The element can then be associated with people elements (331), content resources (333) and/or collections (335). As described with, for example, (220)-(224) (see FIG. 2), and elsewhere, various considerations can be utilized in determining links between elements.

Subsequently, a view can be generated in which the newly added element is displayed with context as determined from the analysis performed in (340). The view can link the newly added element to other elements that reside with the collaborative environment.

In some examples, the user can interact with the provided view (350) to supplement the information provided with the newly added element (352). For example, if the newly added element is a document, the user can manually specify other related documents, update the document added, or specify a collection for the document. If the newly added element is a person element, the user can update the profile information provided, or update the links between the person and other elements. As an addition or variation, the user can view and interact with the linked elements. For example, the user can add a document to a collection and then view the profile of the curator to the collection. The user can also create a new collection for the document.

Element Representation

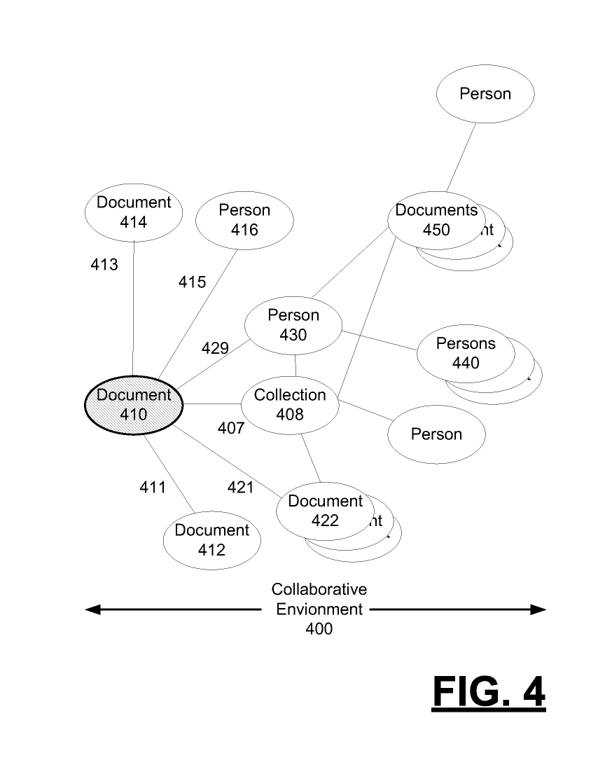

FIG. 4 is an example representation of how an element can be added to a collaborative environment and then linked with other elements based on relevance and the determination of relationships. FIG. 4 illustrates only an example of elements in a collaborative environment, and how elements can be linked with other elements, for purpose of illustrating concepts provided herein.

In the example provided, a document 410 is added to the collaborative environment 400 by being assigned to a collection 408. A link 407 can be associated between the collection 408 and the document 410. For example, a user can specify an existing collection, or create a new collection. When added, metadata can be extracted from the document to identify other documents that have a relationship (e.g., same contributor). Thus, for example, the link 411 to document 412 can be determined from metadata extracted from the document 410. The metadata can also identify the person who is the contributor or author of the document (represented by node 416). The link 415 can be established based on that relationship.

In some embodiments, content from the document (e.g., key words, phrases, pictures, etc.) can be used to determine other documents 414 or content resources that are deemed to be related, on the basis of, for example, subject similarity or relation. For example, the link 413 can be determined from content in the document 410.

Some links between the document 410 and the other elements can be based on the collection 408 that is linked to the document 410. For example, other documents 422 can be assigned to the same collection 408, and the link 421 between the document 410 and the other documents can be based on the documents 410, 422 being assigned to the same collection 408. Likewise, the collection 408 can be linked to persons 430 who are curators of the collection, or contributors of documents 422 of the collection. Based on this relationship, the link 429 can be formed between the document 410 and the persons 430.

In some embodiments, the link between elements can extend multiple degrees of freedom. Thus, in the example provided, the document 410 may be indirectly (e.g., degree of freedom of 2) linked to persons 440, who are linked to persons 430 (followers or curators of the collection 408). Likewise, documents 450 that persons 430 (curators or contributors to collection 408) worked on but which are not part of the collection 408 may be indirectly linked to the document 410. Among other benefits, through the use of direct and indirect links, a user can navigate elements and discover elements that are relevant to the user's interest or search.

Example Interfaces and Views

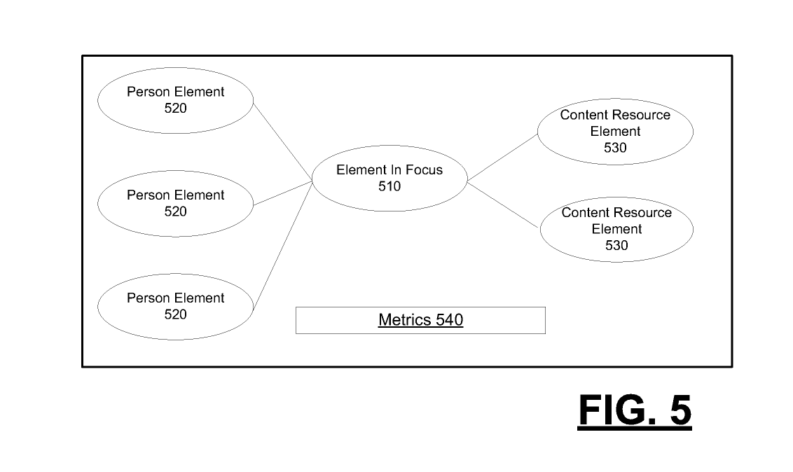

FIG. 5 illustrates an example layout for providing views of elements and linked elements in a collaborative environment. According to some examples, users can select from multiple possible views in order to view a specific element and its relationships to other elements. While multiple views are enabled, some examples recognize a benefit or orienting a user's experience amongst multiple views.

In the example provided by FIG. 5, views can generally be structured in accordance with a layout that designates regions for types of elements. For example, person elements 520 can be provided in a region that is left (or west) of the element in focus 510. In some variations, the person elements 520 correspond to contributors. Other person elements, such as curators, can be provided elsewhere, such as on top (or north) of the element in focus 510. The content resource elements 530 can be provided in a separate region, such as to the right (or east) of the element in focus 510. Still further, metrics 540 corresponding to user activity and social interaction can be provided in another region, such as to the south of the element in focus 510.

Other examples can utilize other orientations and structure. Thus, for example, person elements can be provided in a different region of the layout. The views can sort or arrange elements by type and other characteristics.

Each of the displayed elements can be selected to view information about the element, or to place that selected element in focus. When a different element is selected for in focus, a new set of person elements and content resource elements associated with the specific element in focus is provided in the view. In some embodiments, the particular view that is displayed can also be changed based on the type of element selected.

FIG. 6A through FIG. 6D illustrate example views provided by a presentation. FIG. 6A illustrates an example of a discovery view 600 that displays a selected element in focus 610. The element in focus 610 may correspond to, for example, a collection. Person elements 612 related to the element in focus 610 are provided to the left/west (persons who created the element 610), and content resources (e.g., documents, records) related to the element in focus are provided to the right/east. Metrics 620 reflecting activity taken by users of the collaborative environment for the element in focus 610 are provided to the bottom or south of discovery view 600. In some implementations, persons who are curators, for example, can be displayed as elements 630 above or to the north of the item in focus 610.

FIG. 6B illustrates an alternative view 602 in which the element in focus 610 is a document. As a document, a set of collections 640 can be provided above or to the north of the element in focus. The general organization structure of the alternative view 602 may be the same, with person elements 612 appearing west, linked content resources appearing east, and the set of collections 640 being north.

FIG. 6C illustrates an example of a profile view, according to one or more embodiments. In the profile view 650, a person element 660 is prominently displayed as the element in focus. As with other examples, related elements can be provided for the person element depicted, and related elements can be structured based on a layout that is used across multiple views. For example, related person elements 664 can be displayed to the left, or west, of the person elements 660. Content resources 668 and/or collections relevant to the person elements 660 may be displayed to the right, or east, of the person elements 660. Metrics 670 can display activity of a user in relation to elements of the collaborative network. Detailed activity 672 can optionally be displayed as well. Thus, for example, a person can elect to view the person elements 660, and readily view related persons (e.g., people who work on the same collaborations or documents or collections), as well as what content resources or collections that that person has worked on. Separate regions may be provided to display content resources and collections on a profile view. For example, related collections 675 (e.g., collections the user is a member of, curator for, contributor, follows, etc.) can be displayed at, for example, a bottom right region. Metrics relating to user activity and other details may be provided in another designated region (e.g., bottom right region).

FIG. 6D illustrates an example of a portal view 680 The portal view 680 can depict, for example, recent activity of a specific user, people related to the particular user, assets of the user (content resources and collections) and activity of that user. As an example, a person can use a portal view 680 to view colleagues 682, their recent activity 684, the recommended or recently used assets 686, the collections they curate or which are a member of, and detailed information about their activities in relation to the collaborative resources of the network.

With further reference to FIG. 6A through FIG. 6D, a user can select a new element for focus by dragging it into an iconic feature 654. In response to the user's selection action, other elements that are deemed relevant to the selected element can be identified. Thus, the user action can, for example, result in the identification of other linked elements. In one implementation, the element selected by the user is dropped to the center, prominent position (in response to the user selecting the element by dragging it to the iconic feature 654). The selected element is then displayed in focus, and related elements are displayed about the selected element. The general organization of the view may provide that the people elements relevant to the selected element are displayed in a particular region (e.g., west), while relevant content resources are displayed in another (e.g., east) and collections in another (e.g., north). Any metrics that are associated with the selected element can be provided in another region (e.g., south).

The user can also drag a new data item (e.g., document) to feature 655 to cause that item to publish and be added to the collaborative environment.

Examples herein recognize that different computing environments may require different views. For example, mobile devices are increasingly used in enterprise networks, but such devices typically have limited screen displays. FIG. 7A through FIG. 7D illustrate views that can be rendered on alternative computing platforms, such as small form factor computing devices, to enable viewing of elements and respective links to elements. Examples of small form factor devices include mobile telephony devices that use cellular communications, messaging devices, tablets, and other devices that may emphasize portability. While some functionality described with FIG. 7A through FIG. 7D is described in the context of small form factor devices, examples recognize that such functionality can readily be incorporated with other views or functionality described elsewhere in this application.

FIG. 7A illustrates an example of a collection view 710, according to an example. The collection view can depict portions of content resources 711 (documents, etc.) that associate with a particular collection. Additionally, functionality can be provided to view, for example, person elements related to the collection which can be selected to view a profile or person element that belongs in the collection. Other activity related to the collection can be viewed through followers 714, which represents a feature that can be selected to view other persons who are following the collection. A related elements feature 716 can be selected to view elements that are related to the collection element being displayed (see e.g., FIG. 4 and related text).

The collection view 710 can be provided in the context of a framework 705 which provides multiple features for switching amongst views. For example, a user can select from the framework 705, a feature 720 representing a portal view, a feature 730 representing a profile view, and a feature 740 representing a capture interface (to add the content resource to a collection or to the collaborative environment). In some implementations, numeric identifiers can be displayed with the features of the framework 705 such as, for example, an indication of events relating to the number of elements that the particular user is following.

The framework 705 can also include features 725 for navigation by the user between views and amongst elements. In addition to navigation feature 725, the user can utilize a feature 728 to elect to follow, or not follow, a collection, or a content resource provided in the collection.

FIG. 7B illustrates an example of a content resource (e.g., slide deck) 730 that is viewed from the collection in FIG. 7A. The user can use a feature 732 to add a comment, for example, when viewing the content resource. Any comment entered by the user can then be associated with the element and displayed when other users view the element. The comments provided from individual users can also be tabulated and made part of the metrics for the particular element. As an addition or variation to providing comments, the users can perform other activities on a displayed element, such as collect it, like it, rate it or recommend it.

FIG. 7C and FIG. 7D illustrate alternative examples of an interface for enabling a user to add an element to a collection. In FIG. 7C and FIG. 7D, example interfaces 740, 742 can be operated by the user to add a data item to a collection. The data item can be newly created so as to become an element of the collaborative environment. Alternatively, an element can be selected from a collection and added to a new collection.

Hardware Diagram

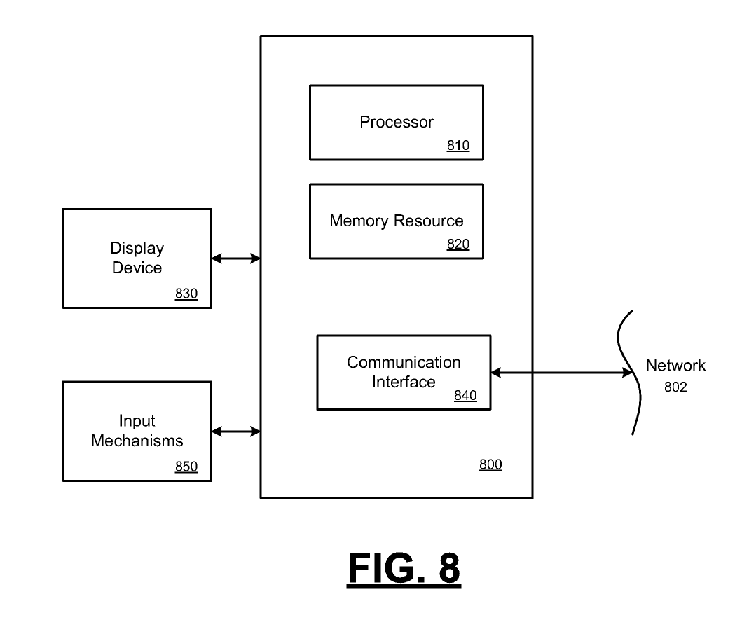

FIG. 8 illustrates an example hardware diagram for a computer system upon which examples described herein may be implemented. For example, in the context of FIG. 1, a system 100 can be implemented in part using a computer system (e.g., server, work station, terminal, etc.) such as described by an example of FIG. 8. According to various examples, the computing device 800 can correspond to one of a mobile computing device (e.g., cellular device that is capable of telephony, messaging, and data services), tablet, laptop, netbook, media playback device, smart television, media playback device, projector, camera, or personal computer. The computing device 800 includes a processor 810, memory resources 820, a display device 830, one or more communication interfaces 840, and one or more input mechanisms 850. The communication interfaces 840 can access from a network 802, for example, a library of elements 105 (see FIG. 1) that form part of a collaborative environment. The memory resources 820 can also store elements of the collaborative environment, as well as instructions for displaying views of elements and related elements.

The processor 810 can be configured with software and/or other logic to perform one or more processes, steps and other functions described with embodiments, such as described by example methods of FIG. 2 and FIG. 3, and elsewhere in this document. Processor 810 can be configured, with instructions and data stored in the memory resources 820, to implement functionality such as described with system 100. For example, instructions for generating links amongst elements of the collaborative environment, as well as presenting views of elements and their links, can be stored in the memory resources 820.

The processor 810 can display views, elements, and described functionality through use of the display 830, by executing instructions and/or applications that are stored in the memory resources 820.

Although illustrative examples have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

What is claimed is:

1. A method for sharing information about resources of a collaborative environment, the method being implemented by one or more processors and comprising:
defining a plurality of elements, each of the plurality of elements corresponding to one of a content resource, a person, or a collection;
determining a plurality of links between the plurality of elements, each link identifying an element that is relevant to another element; and
providing a presentation for a selected element from the plurality of elements, the presentation comprising one or more views, each view concurrently displaying (i) the selected element in focus, corresponding to one of a content resource, a person, or a collection, (ii) a first set of elements corresponding to a set of persons that are linked to the element in focus, (iii) a second set of elements corresponding to one or more collections that are linked to the element in focus, and (iv) a third set of elements corresponding to one or more content resources that are linked to the element in focus.

2. The method of claim 1, wherein providing the presentation comprises providing a discovery view for a content resource that is in focus, the discovery view concurrently displaying (i) a content resource as the selected element in focus, (ii) the first set of elements including one or more persons that are a curator or a contributor of the content resource in focus, and (iii) the second set of elements corresponding to one or more collections that the content resource is linked to.

3. The method of claim 2, wherein determining a plurality of links comprises using one of metadata or content from the content resource to identify a set of relevant content resources that are relevant to the first content resource, and wherein providing the discovery view includes providing the third set of elements corresponding to one or more content resources in the set of relevant content resources.

4. The method of claim 1, wherein providing the presentation comprises providing a profile view for a person that is in focus, the profile view concurrently displaying (i) a profile information for the person in focus, (ii) the first set of elements including one or more persons that are deemed relevant to the person in focus, and (iii) the second set of elements corresponding to one or more collections that the person in focus is linked to.

5. The method of claim 4, wherein determining the plurality of links comprises determining one or more persons that are deemed relevant to the person in focus by (i) identifying one or more collections that the person in focus is a contributor or curator for, and (ii) identifying one or more persons that are contributors or curators for the same one or more collections.

6. The method of claim 1, wherein providing the presentation comprises providing a collection view for a collection that is in focus, the collection view concurrently displaying (i) a collection as the selected element in focus, (ii) the first set of elements including one or more persons that are a curator or a contributor of the collection in focus, and (iii) the second set of elements corresponding to one or more content resources that are part of the collection in focus.

7. The method of claim 1, wherein providing the presentation comprises enabling a user to enter input for the selected element in focus, and selecting the view based on the element that is selected to be in focus by the user.

8. The method of claim 1, further comprising:
enabling one or more types of activities to be performed by a group of persons that can view the content resources of the collection, and
displaying, as part of the plurality of representations, one or more metrics that are based on the one or more types of activities.

9. The method of claim 8, wherein the one or more types of activities comprises a person in the group following the collection, and wherein displaying the one or more metrics comprises displaying a count of a number of persons that are following the collection.

10. The method of claim 9, further comprising providing a notification to each person in the group in response to a predefined change in the collection of content resources.

11. The method of claim 8, wherein the one or more types of activities comprises a person in the group viewing one or more content resources of the collection, and wherein displaying the one or more metrics includes displaying a count of a number of persons that have viewed one or more content resources in the collection.

12. The method of claim 1, wherein the presentation comprises a plurality of views, including a discovery view, a profile view and a collection view, and wherein each of the plurality of views display the selected element in focus in a center.

13. The method of claim 12, wherein each view comprises a defined set of regions for displaying each type of element that is linked to the selected element in focus, the defined set of regions comprising a first region that displays the first set of elements that correspond to the set of persons that are linked to the selected element in focus, a second region that displays the second set of elements that correspond to one or more collections that are linked to the selected element in focus, and a third region that displays the third set of elements that correspond to the one or more content resources that are linked to the selected element in focus.

14. A method for sharing information about resources of a collaborative environment, the method being implemented by one or more processors and comprising:
defining a plurality of elements, each of the plurality of elements corresponding to one of a content resource, a person, or a collection;
determining a plurality of links between the plurality of elements, each link identifying an element that is relevant to another element;
wherein the plurality of elements include one or more collections, each of the one or more collections being linked with a plurality of elements that represent (i) a set of content resources that are assigned to the collection, (ii) one or more persons who are curators for the collection, and (iii) one or more persons who are contributors for the collection.

15. A method for sharing information about resources of a collaborative environment, the method being implemented by one or more processors and comprising:
providing a feature to enable a user to specify an element, the element representing any one of a person, a content resource, or a collection;
in response to the user specifying the element, determining a plurality of related elements for the specified element, the plurality of related elements including each of (i) an element representing a person that is relevant to the specified element, and (ii) an element representing a content resource that is relevant to the specified element; and
providing a view that displays the specified element and the plurality of elements.
